(19) United States
(12) Patent Application Publication
(10) Pub. No.: US 2005/0289600 A1
(43) Pub. Date: Dec. 29, 2005

(54) Information processor, method thereof, program thereof, recording medium storing the program and information recorder

(75) Inventors: Tetsuya Kawahara, Tokorozawa-shi (JP); Yukio Numakami, Tokorozawa-shi (JP); Harumi Nakamura, Tokorozawa-shi (JP); Koji Matsuura, Tokorozawa-shi (JP); Tomoharu Kirihara, Tokorozawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 11/141,210

(22) Filed: Jun. 1, 2005

(30) Foreign Application Priority Data
Jun. 2, 2004 (JP) 2004-164935

(51) Int. Cl. H04N 5/445; G06F 13/00

(52) U.S. Cl. 725/53; 725/52

(57) ABSTRACT

When request information for receiving or reproducing contents data of a TV program of a predetermined detail due to an input on an input unit 260 of a recording/reproducing device 200 is recognized, a genre or a keyword for the requested contents data is recognized. A basic program information about the genre or the keyword is searched based on a program information table generated from EPG data. By generating history information in which the genre and the keyword are associated, and computing an appearance frequency of the combination, a user's preference can be judged. The contents data is received based on the basic program information including requested genre or information and corresponding to the history information with high appearance frequency. Thus, unnecessary receiving can be prevented, so that the contents data can be appropriately retrieved

### BACKGROUND OF THE INVENTION

1. Field of the Invention

The present invention relates to an information processor for retrieving information of a predetermined detail based on guide information about a guide of information by an information retriever, a method thereof, a program thereof, a recording medium storing the program and an information recorder.

2. Description of Related Art

Conventionally, as a recorder for recording a broadcast program, there has been known a device, for instance, for automatically setting timer-recording for a desired program. As such recording device, there has been known an arrangement for automatically recording a program corresponding to a keyword related to a program a user desires to record based on an electric program guide as a guide for programs (see, for instance, Reference 1: Japanese Laid-Open Patent Publication No. 2000-175141, and Reference 2: Japanese Laid-Open Patent Publication No. 2003-309787).

Reference 1 disclosed an arrangement in which broadcast program information is received and program data such as a keyword distinguishing a program is extracted to be accumulated in a table structure. Then, a searching keyword for distinguishing a desired program the user selected to record and the program data are collated, and a timer-recording table is created for candidate recording programs of the corresponding program data. In the arrangement, video data of one of the candidate recording programs is recorded at a broadcasting start time stored in the timer-recording table.

The Reference 2 discloses an arrangement in which a keyword is downloaded from a server connected to the internet through a modem for setting a program selection parameter for automatic recording, the keyword written and stored in a modification area of a keyword storage area in a recording medium built into a recording medium section. The keyword is stored in a fixed area of the keyword storage area. For each of genres such as “drama”, “sports”, “music”, “variety” and “movie” which can be selected with a simple setting, program selecting parameters including a plurality of genres, keywords, and broadcasting hours, each having a priority is assigned, has been prepared in advance. In the arrangement, the program selecting parameter for the automatic recording can be set by selecting a genre, so that an input unit such as keyboard does not have to be provided.

In the conventional arrangement as the one disclosed in the Reference 1, where program data corresponding to a keyword is extracted from program information, for instance, when “tora” (Translator's comment: meaning “tiger” in Japanese) is set as the keyword, other words including “tora” such as “resutoran” (Translator's comment: meaning “restaurant” in Japanese), “osutoraria” (Translator's comment: meaning “Australia” in Japanese), “hottorain” (Translator's comment: meaning “hotline” in Japanese) and “toraburu” (Translator's comment: meaning “trouble” in Japanese) are searched in addition to “tora” as an animal. Thus, since undesired programs are also recorded automatically, a desired program has to be searched from a plurality of the automatically-recorded programs, which is bothersome. On the other hand, in the conventional arrangement disclosed in the Reference 2, where keywords having been set in advance, it is difficult to satisfy a variety of interests and preferences of users with limited keywords. Moreover, a large number of keywords have to be set for satisfying the interests and preferences of the users, bothersome operations are required such as setting keywords and selecting a keyword desired by a user from the large number of keywords.

### SUMMARY OF THE INVENTION

An object of the present invention is to provide an information processor capable of appropriately retrieving predetermined information, a method thereof, a program thereof and a recording medium storing the program, and an information recorder.

An information processor according to an aspect of the present invention retrieves information of a predetermined detail based on guide information about a guide of the information by an information retriever, the information processor including: a request information retriever for retrieving request information for retrieving the information having the predetermined detail by the information retriever; a detail recognizer for recognizing a detail of the information retrieved by the information retriever based on the guide information; a detail frequency computer for generating detail frequency information obtained by computing an appearance frequency of the recognized content; and an information retrieval controller for controlling the information retriever, when retrieval of the request information is recognized, to retrieve the information based on the guide information of the guide corresponding to the predetermined detail and corresponding to the detail according to the appearance frequency in the detail frequency information.

An information processor according to another aspect of the present invention retrieves information of a predetermined detail based on guide information about a guide of the information by an information retriever, the information processor including: a request information retriever for retrieving request information for retrieving the information having the predetermined detail by the information retriever; a detail recognizer for recognizing a detail of the information processed by an information processing unit for processing the information, a detail frequency computer for generating detail frequency information obtained by computing an appearance frequency of the recognized content; and an information retrieval controller for controlling the information retriever, when retrieval of the request information is recognized, to retrieve the information based on the guide information of the guide corresponding to the predetermined detail and corresponding to the detail according to the appearance frequency in the detail frequency information.

An information recorder according to still another aspect of the present invention includes: the above-described information processor of the present invention; an information retrieval controller for retrieving information; a guide information retriever for retrieving guide information about a guide of the information; and a storage for storing the retrieved information.

An information processing method according to further aspect of the present invention, in which a computing unit retrieves information of a predetermined detail based on guide information about a guide of the information by an information retriever, includes the steps of: recognizing a detail of the information retrieved by the information retriever based on the guide information; generating detail frequency information by computing an appearance frequency of the recognized content; and retrieving by the information retriever, when recognizing request information for retrieving the information of the predetermined detail, the information based on the guide information of the guide corresponding to the predetermined detail and corresponding to the detail according to the appearance frequency in the detail frequency information.

An information processing method according to still further aspect of the present invention, in which a computing unit retrieves information of a predetermined detail based on guide information about a guide of the information by an information retriever, includes the steps of: recognizing a detail of the information processed by an information processor for processing the information, and generating detail frequency information by computing an appearance frequency of the recognized content; and retrieving by the information retriever, when recognizing request information for retrieving the information of the predetermined detail, the information based on the guide information of the guide corresponding to the predetermined detail and corresponding to the detail according to the appearance frequency in the detail frequency information.

An information processing program according to still further aspect of the present invention operates a computing unit to function as the above-described information processor of the present invention.

An information processing program according to yet further aspect of the present invention operates a computing unit to execute the above-described information processing method of the present invention.

A recording medium according to yet further aspect of the present invention stores the above-described information processing program of the present invention in a manner readable by a computing unit.

### BRIEF DESCRIPTION OF THE DRAWINGS

FIG. 1 is a block diagram briefly showing the arrangement of a recording/reproducing system in an information recorder according to an embodiment of the present invention;

FIG. 2 is a schematic diagram briefly showing the arrangement of a program information table of the embodiment;

FIG. 3 is a schematic diagram briefly showing the arrangement of a timer-recording list of the embodiment;

FIG. 4 is a schematic diagram briefly showing the arrangement of a contents management list of the embodiment;

FIG. 5 is a schematic diagram briefly showing the arrangement of a history frequency information table of the embodiment;

FIG. 6 is a schematic diagram briefly showing the arrangement of a CPU of the embodiment;

FIG. 7 is a flowchart showing a flow of a timer-recording process of the embodiment;

FIG. 8 is a flowchart showing a flow of an output process of the embodiment; and

FIG. 9 is a schematic diagram briefly showing the arrangement of a data structure of a correlation table used for computing a detail frequency according to another embodiment of the present invention.

### DETAILED DESCRIPTION OF PREFERRED EMBODIMENT(S)

An embodiment of the present invention will be described below with reference to the attached drawings. In the present embodiment, a recording/reproducing device as an information recorder having an information processor of the present invention is exemplified, but the present invention may also be applied to a recorder only recording information and an independent information processor for recording information on the recorder or the recording/reproducing device. The present embodiment exemplifies a process for retrieving contents data of a TV program (information) based on an EPG (Electric Program Guide) as program information (guide information) of broadcast programs, but the arrangement is not limited thereto, and any other arrangements may be employed, where the information can be a broadcasted contents such as radio broadcast programs and satellite broadcast programs, a distributed contents such as music and video, and a contents of various programs such as game software created by an individual and sharable, which are retrieved based on guide information about a guide including a name or a detail of each information. A process for recording information is referred to as a process for recording contents, while a process for information is referred to as a process for reproducing the contents.

[Arrangement of Contents Recording/Reproducing System]

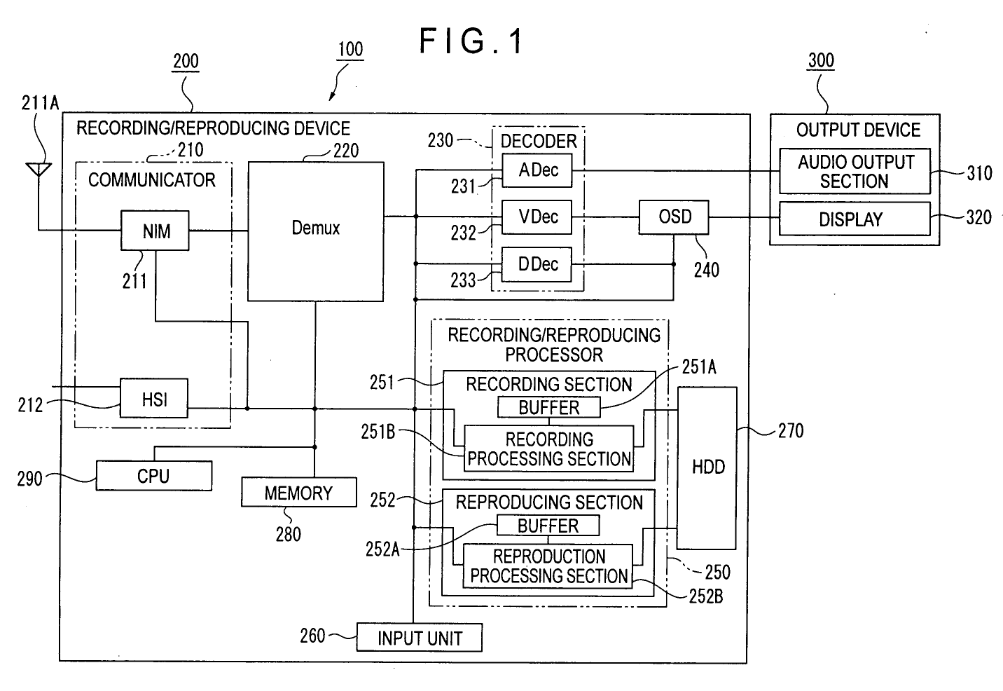

In FIG. 1, a reference numeral 100 is a contents recording/reproducing system (hereinafter referred to as recording/reproducing system) for recoding, for instance, contents data including audio data, video data, data casting data, etc. of a contents (information) such as TV program, and reproducing the recorded contents data. The recording/reproducing system 100 includes a recording/reproducing device 200 as an information recorder and an output device 300 (information processing unit).

The output device 300 includes, for instance, a personal computer, a television, a mobile phone, a PHS (Personal Handyphone System), a PDA (Personal Digital Assistant), and so on. The output device 300 receives and outputs contents data output from the recording/reproducing device 200. The output device 300 includes an audio output section 310, a display 320, etc.

The audio output section 310 includes a sound generator such as speaker (not shown). The audio output section 310 outputs audio data sent as an analogue signal by the recording/reproducing device 200 from the sound generator as a sound. Incidentally, the sound generator can also output, for instance, TV audio data received by a TV receiver (not shown).

The display 320 displays video data, broadcast data, EPG data, combined data, etc. sent by the recording/reproducing device 200 as an analogue signal and a digital signal. The video data displayed herein includes a video of a contents. The broadcast data includes a caption of a contents, a data casting and the like. EPG data includes, for instance, a program list as an electric broadcast guide listing a program name, a detail, a broadcasting time/date, etc. of a contents broadcasted in each channel. The combined data includes a combined video in which a caption is superposed on a video of the contents, a video displaying a data casting and a program list side by side. As the display 320, a liquid crystal display panel, an organic EL (Electro Luminescence) panel, a PDP (Plasma Display Panel), a CRT (Cathode-Ray Tube), a FED (Field Emission Display) and an electrophoretic display panel may be employed. Incidentally, the display 320 can also output, for instance, TV video data received by the TV receiver.

The recording/reproducing device 200 retrieves and records contents data including audio data, video data, data casting data, etc. distributed as TS (Transport Stream) and outputs the contents data from the output device 300. The recording/reproducing device 200 reproduces the recorded contents data to be output from the output device 300. In addition, the recording/reproducing device 200 automatically deletes the recorded contents data. The recording/reproducing device 200 includes a communicator 210 functioning as an information retriever and a guide information retriever, a demultiplexer (Demultiplexer; Demux) 220, a decoder 230, an on-screen display (On Screen Display; OSD) 240, a recording/reproducing processor 250, an input unit 260, a hard disk (Hard Disk Drive; HDD) 270 as a storage, a memory 280, a CPU (Central Processing Unit) 290 as an information processor being a computing unit, and the like.

The communicator 210 retrieves contents data input from the outside and outputs the retrieved contents data to the outside. The communicator 210 includes a network interface module (Network Interface Module; NIM) 211, a high speed interface (High Speed Interface; HSI) 212, etc.

The NIM211 is connected to an antenna 211A for receiving broadcast wave of terrestrial digital broadcasting, satellite digital broadcasting and the like. The NIM 211 is also connected to the Demux 220 and the CPU 290, etc. The NIM 211 retrieves a TS corresponding to a contents selected by a user from a plurality of TSs sent as digital signals from the antenna 211A under the control of the CPU 290. The NIM 211 outputs the retrieved TS to the Demux 220.

The HSI 212 is an interface capable of high-speed data processing, which includes, for instance, an interface of IEEE (Institute of Electrical and Electronic Engineers) 1394 standard and an interface for connecting to the internet. The HSI 212 is connected to the Demux 220 and the recording/reproducing processor 250. The HSI 212 retrieves a TS and a partial TS (described later) sent as a digital signal from an external device (not shown) provided outside the recording/reproducing device 200, and outputs the TS and the partial TS to the Demux 220. Also, the HSI 212 retrieves and processes a partial TS output from the recording/reproducing processor 250 to send as a digital signal to the external device (not shown) provided outside the recording/reproducing device 200.

The Demux 220 retrieves a TS and separates a TS packet from the TS to output the TS packet. The Demux 220 is connected to the decoder 230, the recording/reproducing processor 250, the CPU 290, etc. The Demux 220 retrieves the TSs from the NIM 211 and HSI 212 under the control of the CPU 290. Then, TS packets of various data corresponding to selected contents are retrieved from the TSs. More specifically, the Demux 220 retrieves a TS packet embedding audio data (hereinafter, referred to as audio packet), a TS packet embedding video data (hereinafter, referred to as video packet) and a TS packet embedding data casting data or EPG data (hereinafter, referred to as data packet). The Demux 220 outputs the retrieved audio packet, video packet and data packet to the decoder 230.

In the EPG data, information about the contents such as TV program of each TS that can be retrieved by the NIM 211 is indicated in a text format such as BML (Broadcast Markup Language) and XML (eXtensible Markup Language). Although described later in detail, the EPG data is constituted as a data structure including a program description regarding a program name, a detail of program, etc., and information such as start time/date, broadcasting time length, channel, genre, series name.

Once the Demux 220 retrieves each of the TS packets corresponding to the selected contents from the retrieved TSs under the control the CPU 290, the Demux 220 restructures each of the TS packets into a set of data array structure, namely, a partial TS. The partial TS is output to the recording/reproducing processor 250. The Demux 220 retrieves the partial TS from the HSI 212 and the recording/reproducing processor 250 under the control of the CPU 290. The Demux 220 then separates the partial TS into the audio packet, the video packet and the data packet to output the separated packets to the decoder 230.

The decoder 230 is connected to the Demux 220, the OSD 240, the CPU 290, the output device 300, etc., the decoder 230 decoding each of the packets retrieved from the Demux 220 to output the packet to the OSD 240 and the output device 300. The decoder 230 includes an audio decoder (Audio Decoder; ADec) 231, a video decoder (Video Decoder; VDec) 232 and a data decoder (Data Decoder; DDec) 233.

The ADec 231 is connected to the audio output section 310 of the output device 300. The ADec 231 retrieves the audio packet from the Demux 220 under the control of the CPU 290. The audio data embedded in the audio packet is decoded, and sent to the audio output section 310 of the audio output device 300 as an analogue signal.

The VDec 232 is connected to the OSD 240. The VDec 232 retrieves the video packet from the Demux 220 under the control of the CPU 290. The video data embedded into the video packet is then decoded, and output to the OSD 240.

The DDec 233 is connected to the OSD 240. The DDec 233 retrieves the data packet from the Demux 220 under the control of the CPU 290. The data casting data, the EPG data, etc. embedded into the data packet is then decoded, and output to the OSD 240. When the EPG data is embedded into the data packet, the DDec 233 outputs the EPG data to the HDD 270 under the control of the CPU 290.

The OSD 240 is connected to the CPU 290 and the display 320 of the output device 300. The OSD 240 retrieves the video data from the VDec 232 under the control of the CPU 290. The OSD 240 also retrieves the data casting data and the EPG data from the DDec 233. Then, for instance, the OSD 240 generates combined data for displaying a video based on the video data, a caption based on the data casting data and a program list based on the EPG data selectively in a superposing manner or in a side-by-side manner. The OSD 240 then sends the combined data to the display 320 of the output device 300 as an analogue signal. Also, the OSD 240 outputs each of the video data, the data casting data and the EPG data individually to the display 320 as an analogue signal.

The recording/reproducing processor 250 is connected to the HDD 270, the CPU 290, etc. The recording/reproducing processor 250 retrieves the partial TS from the Demux 220 to store it in the HDD 270. The recording/reproducing processor 250 also retrieves the partial TS stored in the HDD 270 and outputs the partial TS to the HSI 212 and the Demux 220. The recording/reproducing processor 250 includes a recording section 251 and a reproducing section 252.

The recording section 251 stores the partial TS retrieved from the Demux 220 in the HDD 270. The recording section 251 includes a buffer 251A, a recording processing section 251B, and the like. The buffer 251A temporarily stores the partial TS retrieved from the Demux 220. The recording processing section 251B retrieves the partial TS from the Demux 220 to readably store it in the buffer 251A under the control of the CPU 290. The recording processing section 251B reads out the partial TS stored in the buffer 251A to output the read partial TS to the HDD 270.

The reproducing section 252 outputs the partial TS stored in the HDD 270 to the HSI 212 and the Demux 220. The reproducing section 252 includes a buffer 252A, a reproduction processing section 252B, and the like. The buffer 252A temporarily stores the partial TS retrieved from the HDD 270. The reproduction processing section 252B retrieves the partial TS from the HDD 270 to readably store the partial TS in the buffer 252A under the control of the CPU 290. The reproduction processing section 252B reads the partial TS stored in the buffer 252A to output the read partial TS to the HSI 212 and the Demux 220.

The input unit 260 is connected to the CPU 290. The input unit 260 includes various operation buttons and operation knobs (each not shown) provided for input operation, for instance, on a front side of a casing (not shown). The input operation performed on the operation buttons and the operation knobs includes, for instance, settings for operations of the recording/reproducing device 200. More specifically, a setting regarding recording and reproducing of the contents, setting of TS received by the NIM 212 (Translator's comment: correctly, NIM 211) and the like can be exemplified The input unit 260 also functions as a generator for generating request information (described later in detail) for requesting execution of recording and reproducing in accordance with the input operation. The input unit 260 sends various information to the CPU 290 as operation signals by the input operation for the settings. Note that the input unit 260 may have a remote control receiver for receiving the various information sent from a remote controller (not shown) via infrared rays and sending the various information to the CPU 290 as the operation signals.

The HDD 270 is connected to the CPU 290. The HDD 270 is controlled by an ATA (AT Attachment) interface. Incidentally, although the HDD 270 is controlled by the ATA interface in the embodiment, the HDD 270 may also be controlled by an IDE (Integrated Drive Electronics) interface, an SCSI (Small Computer System Interface) interface, and the like. Further, an arrangement having a drive or a driver readably storing various information in various recording media including a detachable medium such as optical disc like a DVD (Digital Versatile Disc), a magnetooptical disc and a memory card as well as a fixed memory, or an arrangement combining a plurality of such drivers and drives may be employed in place of the HDD 270. The HDD 270 readably stores the partial TS of the contents input from the recording section 251, namely, the contents data, the EPG data, etc.

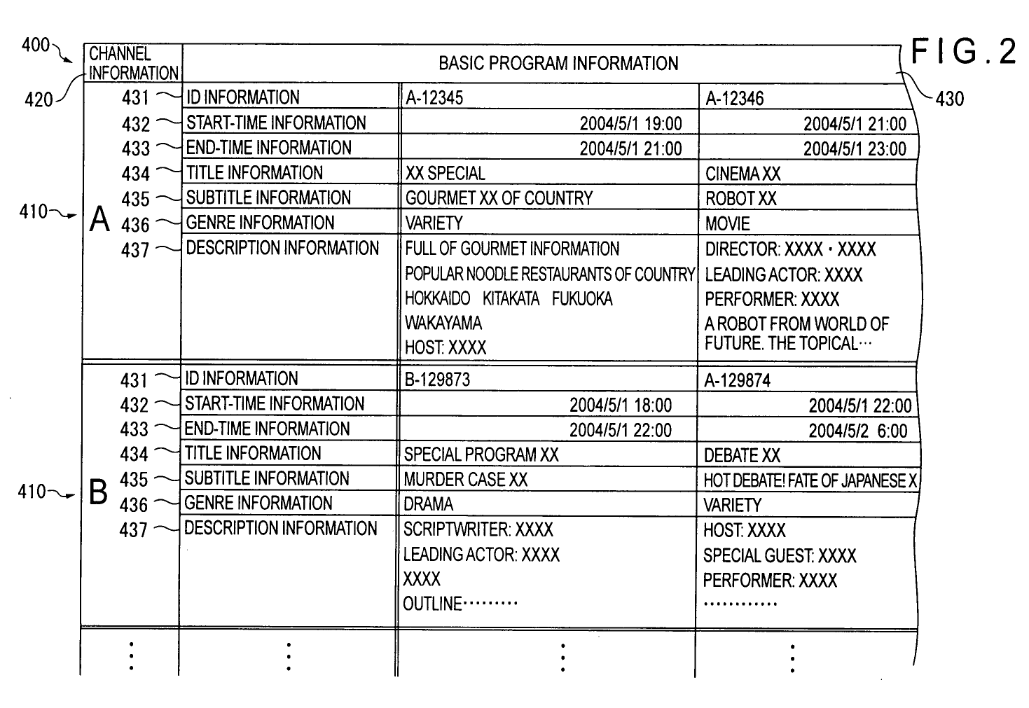

The HDD 270 has a data storage area (not shown) for storing the contents data and an EPG storage area (not shown) for storing the EPG data as a program information table 400 as shown in FIG. 2. Although described later, an area for storing at least one of the EPG data, a timer-recording list 500, a contents management list 600, history frequency information 700 and the like stored in the memory 280 may be provided.

The program information table 400 is generated based on an EPG described in the EPG data output from the OSD 240. The EPG included in broadcast wave transmitted from each broadcast station is program information mainly including TV programs that are scheduled to be broadcasted by the broadcast station. The program information table 400 has a table structure including such EPG of each broadcast station in combination, which is stored in the EPG storage area. The EPG storage area storing the program information table 400 has a table structure for storing plural sets of program information 410 as guide information constituted as a data structure in which, for instance, channel information 420 about a broadcast channel of a TV program, basic program information 430, etc. are mutually associated.

The channel information 420 is information about a channel on which a TV program is broadcasted. The channel information 420 is set individually for each area where the TV program is broadcasted.

In the basic program information 430 detailed information such as broadcasting time and details of the TV program is recorded. The basic program information 430 includes ID information 431, start-time information 432, end-time information 433, title information 434, subtitle information 435, genre information 436, description information 437 and the like, the basic program information 430 being constituted as a data structure. The various information included in the basic program information 430 has a simple structure using a text format, namely character string. Incidentally, the basic program information 430, without limited to the arrangement including the various information, may include additional information or may exclude any of the above information, e.g. the ID information 431.

The ID information 431 is unique identifying information that is assigned to each of the basic program information 430 for identifying a TV program. As the ID information 431, a G-code used for identifying a TV program in timer-recording of the TV program can be exemplified. In addition to the G-code, any unique ID information for identifying a TV program may be employed.

The start-time information 432 is related to a scheduled start time of broadcasting of a TV program. The start-time information 432 includes a date and time for starting broadcasting of the TV program. The start-time information 432 is referred to in generating a timer-recording information list (described later) and in performing a process for starting recording of the TV program in the recording section 251 of the recording/reproducing processor 250.

The end-time information 433 is related to a scheduled termination time of a TV program. The end-time information 433 includes a date and time for terminating broadcasting of the TV program. The end-time information 433 is referred to in performing a process for terminating recording of the TV program in the recording section 251 of the recording/reproducing processor 250

The title information 434 is related to a name such as program name and title of a TV program. The subtitle information 435 is related to a subtitle of a TV program.

The genre information 436 describes which genre a TV program belongs to, when the TV program is categorized by details thereof. For instance, “variety”, “drama”, “movie”, “press report”, “news”, “sports” can be exemplified as the genre. Further, as the genre information 436, for instance, information categorized into sub-genres such as “song” and “entertainment” may be associated with the “variety”.

The description information 437 is information in which detailed information of a TV program, e.g., a simple description about a detail of the TV program, an outline of the program from the previous broadcast, and a personal name such as a performer, a director and a scriptwriter of the TV program are described in the text format.

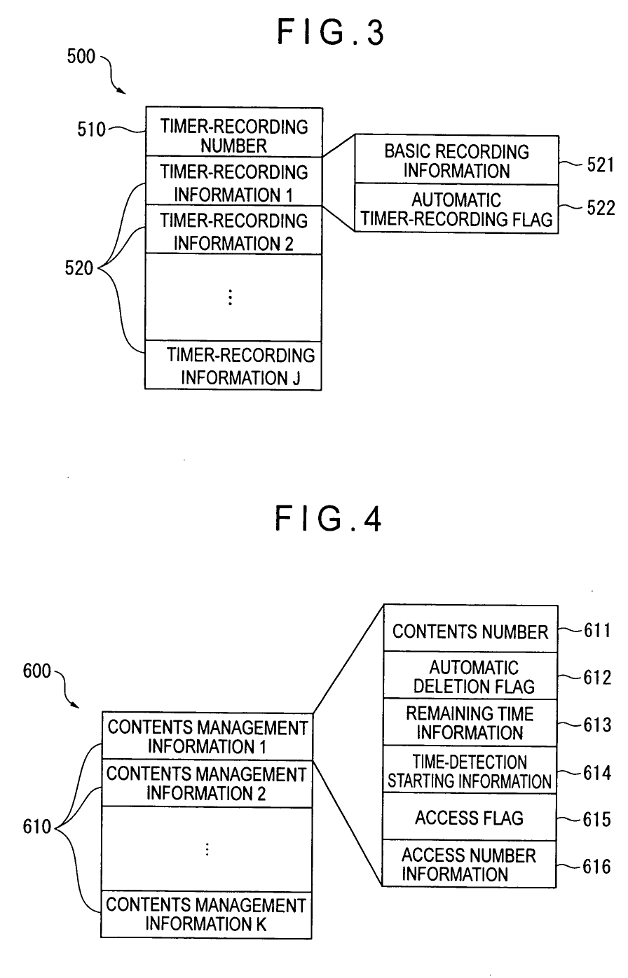

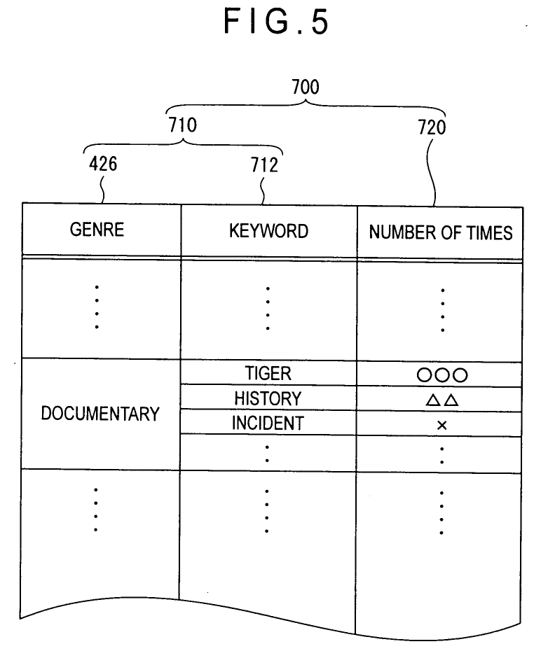

The memory 280 readably stores various data required in retrieving desired contents data from the TS output from the NIM 211 for recording and in reproducing the recorded contents data. The memory 280 readably stores, for instance, a timer-recording list 500 (FIG. 3), a contents management list 600 (FIG. 4) and history frequency information 700 (FIG. 5).

The timer-recording list 500 is related to a list of a manual timer-recording and an automatic timer-recording. The timer-recording list 500 is constituted as a data structure in which, for instance, timer-recording number 510 and at least one timer-recording information 520 are mutually associated.

The timer-recording number 510 is related to the total number of the timer-recording information 520. The timer-recording number 510 is, by the CPU 290, added by one when the manual timer-recording or the automatic timer-recording is set, and reduced by one when recording based on the set manual timer-recording or the set automatic timer-recording is terminated.

The timer-recording information 520 is related to the manual timer-recording or the automatic timer-recording. The timer-recording information 520 is added to the timer-recording list 500 when the manual timer-recording or the automatic timer-recording is set by the CPU 290, and deleted from the timer-recording list 500 when the recording based on the manual timer-recording or the automatic timer-recording is terminated. The timer-recording information 520 is constituted as a data structure in which basic recording information 521, automatic timer-recording flag 522, etc. are mutually associated.

The basic recording information 521 is various information used for executing a manual timer-recording process and an automatic timer-recording process. The basic recording information 521 is constituted as a data structure in which recording start time/date, recording termination time/date, channel, etc. are mutually associated. The basic recording information 521 is appropriately changed by the CPU 290.

The automatic timer-recording flag 522 is flag information indicating whether a recording process based on the basic recording information 521 is the automatic-timer recording process or not. For instance, the automatic timer-recording flag 522 being “0” indicates the manual timer-recording process (not the automatic timer-recording process) and “1” indicates the automatic timer-recording process.

The contents management list 600 is related to a list of information corresponding to the contents recorded in the HDD 270. The contents management list 600 is constituted as a data structure with which at least one of contents management information 610 is associated.

The contents management information 610 is, by the CPU 290, added to the contents management list 600 when a contents is recorded in the HDD 270, and deleted from the contents management list 600 when the contents is deleted from the HDD 270. The contents management information 610 is constituted as a data structure in which a contents number 611, an automatic deletion flag 612 as data attribute information, remaining time information 613, a time-detection starting information 614, an access flag 615 as processing status information, access number information 616 as detail frequency information of the processing status information and the like are mutually associated. The contents management information 610 is associated with, for instance, the basic program information 430 corresponding to the contents and the ID information 431 associated with the basic program information 430. In other words, a detail of the contents data recorded in the HDD 270 can be checked through the contents management information 610.

The contents number 611 is related to number specifically assigned to the contents recorded in the HDD 270. Note that information such as name specifically assigned to the contents may be used instead of the contents number 611.

The automatic deletion flag 612 is flag information indicating whether or not a contents specified by the contents number 611 is targeted to be automatically deleted by the CPU 290. For instance, the automatic deletion flag 612 being “0” indicates that the contents is not targeted to be automatically deleted, and “1” indicates that the contents is targeted to be automatically deleted. The automatic deletion flag 612 is appropriately reset by the CPU 290.

The remaining time information 613 is related to remaining time until the contents specified by the contents number 611 is automatically deleted. The remaining time information 613 is appropriately reset by the CPU 290.

The time-detection starting information 614 is related to time-detecting start date/time indicating a date/time for staring time detection of a period T that has been set in advance. The time-detecting start date/time is a date/time of termination of recording as a data storing date/time of the contents specified by the contents number 611, or a date/time when the remaining time information 613 is changed by the CPU 290. The time-detection starting information 614 is appropriately changed by the CPU 290.

The access flag 615 is flag information indicating whether a process for recording or editing the contents specified by the contents number 611 has been executed at least once or not, in other words, whether the contents has been accessed at least once or not. Specifically, the access flag 615 being “0” indicates that the accessing has never been performed, while “1” indicates that the accessing has been performed at least once. The access flag 615 is appropriately changed by the CPU 290.

The access number information 616 is related to the number of accessing times to the contents specified by the contents number 611. The access number information 616 is appropriately changed by the CPU 290.

The history frequency information 700 is related to a recording history or a reproducing history of contents data having been recorded or reproduced in the past. As shown in FIG. 5, the history frequency information 700 is constituted as a data structure in which pluralities of history information 710, detail frequency information 720, etc. are mutually associated. The history information 710 lists a detail of the contents data having been recorded or reproduced in the past, for instance, in genre basis and keyword basis, which includes genre information 436, keyword information 712 and the like. In addition to the genre and the keyword, any of a related keyword regarding the keyword and a phrase related to the detail of the contents can also be listed. The phrase may include all phrases included in the program information 410, and not only a word but also a sentence related to the detail can be used.

The genre information 436 of the history information 710 is related to a genre of the contents data that has been recorded or reproduced. The genre information 436 is associated with the genre information 436 in the program information table 400.

The keyword information 712 as keyword-related information of the history information 710 is related to the keyword, which is character string information of all phrases including a key word input by a user on the input unit 260 for recording program, a keyword as a phrase extracted from the program information table 400 by morphological analysis, a word used as a keyword, a related keyword, and further, a related detail such as genre, channel information, start time and the like. The keyword information 712 is, through a process of the CPU 290, associated with the genre information 436 of the genre specified based on the genre information 436 of the basic program information 430 including the keyword based on the program information table 400. In other words, a plurality of the keyword information can be associated with the genre information 436 of the history information 710.

The detail frequency information 720 is related to a recording, viewing or reproducing frequency of each detail of contents data having been recorded or reproduced in the past. Specifically, the detail frequency information 720 is an appearance frequency of an input keyword or an appearance frequency of a keyword included in the basic program information 430 corresponding to recorded or reproduced contents data, which is the number of the input times or the number of the appearing times computed and processed by the CPU 290.

The memory 280 readably stores various programs and the like that are run on an OS (Operation System) for controlling the entire operation of the recording/reproducing device 200. As the memory 280, a CMOS (Complementary Metal-Oxide Semiconductor) memory should preferably be used, a storage of which can be preserved even when the power supply is suddenly cut off due to blackout or the like. The memory 280 may include a driver or a drive readably storing the various programs on a detachable recording media such as HD, DVD and optical disc.

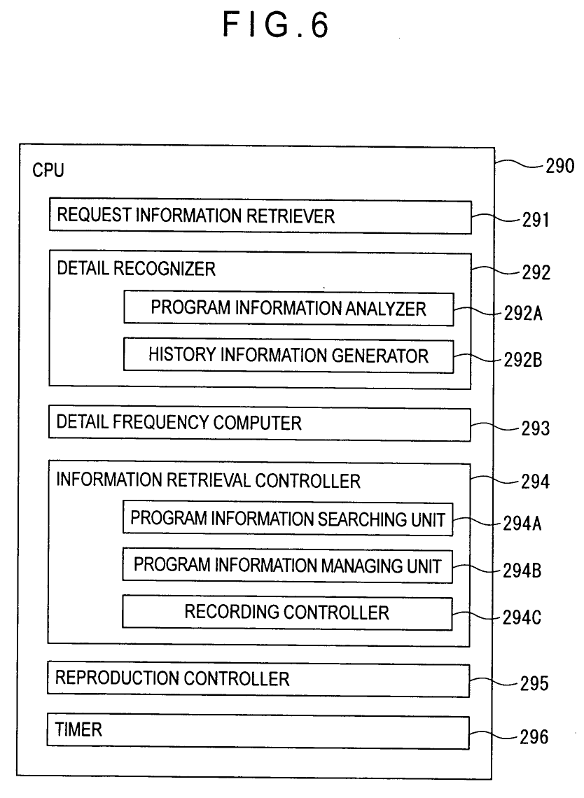

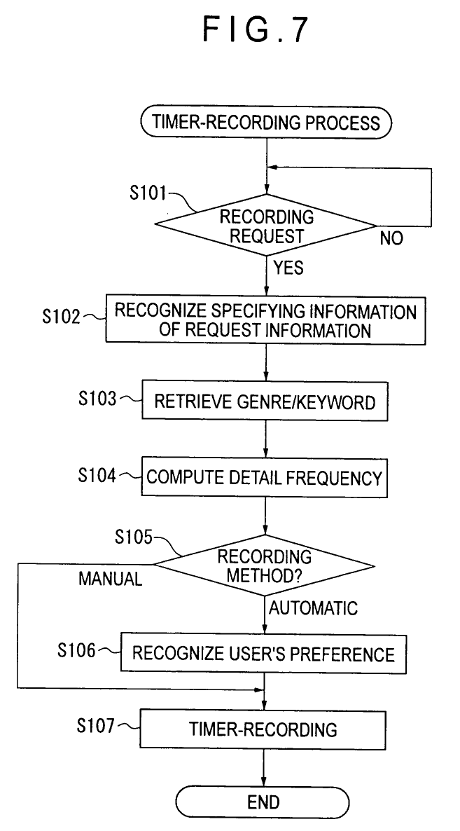

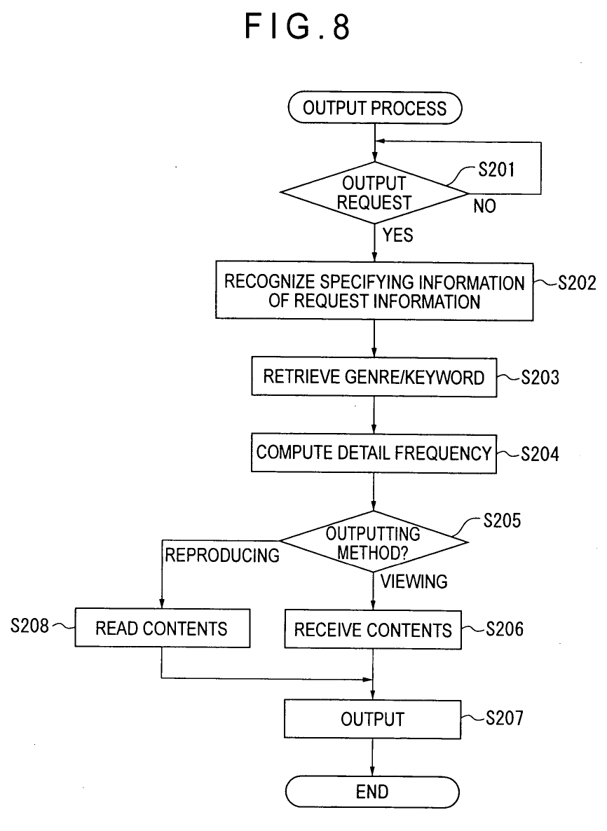

The CPU 290 is connected to various components to control operations of those components. As shown in FIG. 5 (Translator's comment: correctly, FIG. 6), the CPU 290 includes, as various programs, a request information retriever 291, a detail recognizer 292, a detail frequency computer 293, an information retrieval controller 294, a reproduction controller 295, a timer 296 and the like.

The request information retriever 291 retrieves request information input by a predetermined input operation on the input unit 260. The request information allows the communicator 210 to receive and retrieve the contents data corresponding to a predetermined detail such as genre and keyword by, for instance, recording or outputting (viewing or reproducing). In other words, the request information includes specifying information (not shown) such as genre and keyword for specifying a TV program. The request information retriever 291 recognizes whether the manual recording is requested or the automatic recording is requested based on the specifying information. Specifically, the request information retriever 291 recognizes whether the automatic recording is requested based on the genre or the keyword, or the manual recording is requested where the TV program is specified and the contents data of the specified TV program is recorded.

The detail recognizer 292 recognizes a detail of the contents data received by the communicator 210 and stored in the HDD 270 and a detail such as genre and keyword of the contents data stored in the HDD 270 and reproduced by the output device 300. The detail recognizer 292 generates the history information 710 of the history frequency information 700 for the detail of the recorded or reproduced contents data recognized as describe above. Incidentally, although an arrangement of the history information 710 where a history of a detail of contents data deleted from the HDD 270 is also stored will be described, a history having been kept for a certain period of time (e.g. several years) may automatically be deleted. The detail recognizer 292 includes a program information analyzer 292A, a history information generator 292B, etc.

The program information analyzer 292A retrieves the detail such as genre and keyword of the contents data recorded or output by viewing and reproducing based on the basic program information 430 for each recording and output. In other words, the program information analyzer 292A retrieves the corresponding basic program information 430 in the program information table 400 for the contents data recorded by timer-recording or by manual, and retrieves the basic program information 430 based on the corresponding contents management information 610 for the contents data stored and reproduced in the HDD 270. The program information analyzer 292A reads out the genre information 436 of the basic program information 430 and generates a keyword information 712 by extracting a word included in the basic program information 430 by morphological analysis It should be noted that in the request information of the timer-recording, when the genre and the keyword are input, the genre information 436 may be retrieved and the keyword information 712 may be extracted by directly retrieving the genre information 436 and the keyword information 712 related to the genre and by retrieving the corresponding basic program information 430 based on the genre information 436 and the keyword information 712.

The history information generator 292B generates the history information 710 of the history frequency information 700 using the genre information 436 and the keyword information 712 retrieved by the program information analyzer 292A. That is to say, the history information generator 292B generates a data structure in which the genre information 436 of the targeted TV program and the keyword information 712 included in the basic program information 430 of the genre information 436 are mutually associated to list the data structure in the history information 710. Note that, if the same genre information 436 exists in the history information 710, the retrieved keyword information 712 is associated with the same genre information 436 and listed in the history information 710.

Every time the contents data is recorded or output, the detail frequency computer 293 computes appearance frequency of the detail of the contents data to generate detail frequency information. In other words, the detail frequency computer 293 computes the appearance frequency of a combination of a genre and a keyword in the history information 710 of a recording history, a viewing history and a reproducing history. Specifically, in the genre information 436 and the keyword information 712 retrieved by the program information analyzer 292A of the detail recognizer 292 for every recording and output, when the same combination of the genre information 436 and the keyword information 712 has been already stored in the history information 710, the detail frequency computer 293 increases the number. That is, the number of the detail frequency information 720 associated with the history information 710 is added by “1” and updated.

The information retrieval controller 294, once recognizing that the request information retriever 291 retrieves the request information, controls to receive and record through the communicator 210 the contents data corresponding to the requested detail and corresponding to the detail depending on the appearance frequency in the detail frequency information 720 of the history frequency information 700 based on the program information table 400. The information retrieval controller 294 generates the timer-recording information 520 based on the program information table 400 for recording the contents data that corresponds to the genre or the keyword input by a user as a request of the manual timer-recording or the automatic timer-recording from the request information retriever 291. The information retrieval controller 294 includes a program information searching unit 294A, a program information managing unit 294B, a recording controller 295, and the like.

The program information searching unit 294A retrieves the genre information 436 and the keyword information 712 that are input based on the request information. The program information searching unit 294A recognizes, based on the history frequency information 700, the history information 710 of a combination of genre information 436 and keyword information 712 having high appearance frequency of the detail frequency information 720 in the retrieved genre information 436 or the keyword information 712. Specifically, if the genre information 436 is input, the program information searching unit 294A retrieves keyword information 712 having high appearance frequency in keyword information 712 associated with the genre information 436. On the other hand, if the keyword information 712 is input, the program information searching unit 294A retrieves genre information 436 with which keyword information 712 having high appearance frequency in the keyword information associated the keyword information 712 is associated. The retrieved genre information 436 and keyword information 712 are mutually associated as one of request parameter information and stored in the memory 270 (Translator's comment: correctly, memory 280). The program information searching unit 294A searches, based on the retrieved genre information 436 and keyword information 712, basic program information 430 having the retrieved the genre information 436 and including the keyword of the keyword information 712 from the program information table 400. Regarding the genre and the keyword as the request information input for recording request, the request parameter information recorded in the memory 270 (Translator's comment: correctly, memory 280) is not deleted until, for instance, a period of time for the recording request is elapsed or the recording is interrupted or canceled through an input operation.

The program information managing unit 294B generates the timer-recording information 520 based on the basic program information 430 searched by the program information searching unit 294A, and lists it in the timer-recording list 500. Specifically, the recording information managing unit 294B generate the basic recording information 521 based on the basic program information 430, while generating the timer-recording information 520 with the automatic timer-recording flag 522 being set to “1”, which indicates the automatic timer-recording. Further, the program information managing unit 294B adds the number of the timer-recording number 510 by one and lists the generated timer-recording information 520 in the timer-recording list 500, in other words, stores the timer recording information 520 in an area of the memory 280 for storing the timer-recording list 500. The information managing unit 294B basic program information 430 corresponding to information specifying the program from the program information table 400 to generate the timer-recording information 520, the information specifying the program including a case where, for instance, input is operated manually, or ID information 431 for specifying a TV program to be recorded is input and such information is included in the request information. The timer-recording information 520 is generated with the automatic timer-recording flag 522 being set to “0”, which indicates the manual timer-recording. Then, in a manner same as the automatic time-recording, the timer-recording information is listed in the timer-recording list 500.

When the program information managing unit 294B recognizes that the EPG data that is different from the one having been retrieved in advance is received, the program information managing unit 294B judges whether the basic program information 430 of all the timer-recording information 520 in the timer-recording list 500 has been changed or not. If changed, the program information managing unit 294B judges whether the detail is the same or not by judging, for instance, whether the changed basic program information 430 includes the genre information 436 and the keyword information 712 of the basic program information 430 corresponding to the timer-recording information 520, and if not included, the program information managing unit 294B determines that the program has been changed to a different one, and deletes the timer-recording information 520. Note that, when the EPG data is updated, all the timer-recording information 520 of the automatic timer-recording with the automatic timer-recording flag 522 being set to “1” among the timer-recording information 520 may be deleted, and timer-recording information 520 may be newly generated by searching the corresponding basic program information 430 in the same manner as described above based on the request parameter information generated by the program information searching unit and stored in the memory.

The recording controller 294C controls operations of the NIM 211, Demux 220, the recording section 251 of the recording/reproducing processor 250 to receive contents data of a desired TV program and readably store it in the HDD 270. Specifically, the recording controller 294C stores the contents data currently being received and reproduced according to on an operation signal based on input operation on the input unit 260, or receives and stores such contents data that the recording start time of the basic recording information 521 in the timer-recording information 520 overlaps with current time being detected by the timer 296 (described later) based on the timer-recording list 500.

The reproduction controller 295 controls operations of the Demux 220, the decoder 230 and the reproducing section 252 of the recording/reproducing processor 250 to output the desired contents data to the output device 300. Specifically, the reproduction controller 295 reads out from the HDD 270 the contents data specified by the operation signal based on the input operation on the input unit 260, e.g., the contents data specified by the input operation for selecting a thumbnail displayed as a list on the output device 300, or the contents data that has been requested in advance for reproducing at a predetermined time (timer reproducing), to appropriately process the contents data in the decoder 230 to output the decoded contents data to the output device 300.

The timer detects the current time based on a standard pulse of an internal clock or the like to generate current time information.

[Operation of Contents Recording/Reproducing System]

Next, a process for setting a user's preference in the operation of the recording/reproducing system 100 will be described with reference to the attached drawings.

(Setting of Timer-Recording)

The CPU 290 of the recording/reproducing device 200 judges, at the request information retriever 291, whether recording request information as request information for retrieving (recording) contents data of a predetermined TV program is input or not by an input operation of a user on the input unit 260 (step S101). In other words, the CPU 290 is in standby state for input of the request information. Then, when the request information retriever 291 retrieves the recording request information, the request information retriever 291 recognizes specifying information of the recording request information (step S102).

After the step S102, the CPU 290 recognizes various information as the detail of the requested TV program, namely, a genre, a keyword, a channel, a start time, etc., of the TV program (step S103). Specifically, when the automatic recording is requested, genre information 436 about the input genre or keyword information 712 about the input keyword are retrieved from the specifying information by the detail recognizer 292. When the detail recognizer 292 retrieves the genre information 436 as request parameter information, the detail recognizer 292 reads out basic program information 430 including the retrieved genre information 436 based on the program information table 400 generated from the EPG data having been retrieved in advance, and then, extracts a keyword included in the basic program information 430 by the program information analyzer 292A to generate and retrieve the keyword information 712. Then, the history information generator 292B associates the generated keyword information 712 with the genre information 436, and if there are a plurality of the keyword information 712, each of them is mutually associated with the genre information 436 to generate history information 710 having a data structure. On the other hand, when the detail recognizer 292 recognizes the keyword information 712 as request parameter information, the detail recognizer 292 reads out the basic program information 430 including the keyword of the retrieved keyword information 712 based on the program information table 400 generated from the EPG data having been retrieved in advance, and then, retrieves the genre information 436 included in the basic program information 430. Then, the history information generator 292B associates the retrieved genre information 436 with the keyword information 712, and if there are a plurality of the keyword information 712, each of them is associated with the genre information 436 to generate history information 710 having a data structure.

In the manual recording, the detail recognizer 292 reads out basic program information 430 of the requested TV program recognized from the specifying information based on the program information table 400 generated from the EPG data retrieved and reproduced in advance, and then, retrieves the genre information 436 of the read basic program information 430, while extracting the keyword included in the basic program information 430 by the program information analyzer 292A to generate and retrieve the keyword information 712. The CPU 290 associates, based on the retrieved genre information 436 and keyword information 712, the genre information 436 and the keyword information 712, and if there are a plurality of the keyword information 712, each of them is mutually associated with each of the program genre information 436 to generate by the history information generator 292B the history information 710 as the request parameter information having a data structure.

Then, the CPU 290 computes the detail frequency information 720 about the appearance frequency of the generated history information 710 by the detail frequency computer 293. That is to say, the CPU 290 judges whether the generated history information 710 exists in the history information 710 of the history frequency information 700, and if not exists, the CPU 290 lists the generated history information 710 in the history frequency information 700 and performs computation to set the detail frequency information to “1”. If exists, the CPU 290 performs computation to add “1” to the detail frequency information associated to the history information 710 (step S104).

After the step S104, the CPU 290 judges if the recording is performed automatically or manually by the recording controller 294C of the information retrieval controller 294, more specifically, the CPU 290 judges whether the automatic recording is requested based on the genre or the keyword or the manual recording is requested for recording the contents data of the TV program having been specified, based on the specifying information recognized in the step S102 (step S105). In the step S105, if the CPU 290 judges that the automatic recording is requested, the information retrieval controller 294 judges the preference of the user based on the genre information 436 or the keyword information 712 retrieved from the specifying information in the step S102 (step S107). That is to say, the information retrieval controller 294 retrieves history information 710 with high appearance frequency of the detail frequency information 720 associated with the history information 710, i.e. the history information 710 having the highest value of the number of detail frequency information 720, or a plurality of history information 710 in descending order of the value. Note that, judgment of the user's preference may also be made based on whether programs automatically recorded are redundant or not, whether a recording capacity has to be saved or not, and the like.

After the step S106, the CPU 290 generates timer-recording information 720 (Translator's comment: correctly, timer-recording information 520) based on the history information retrieved by the information retrieval controller 294 in the step S106 (step S107). In other words, the program information managing unit 294B of the information retrieval controller 294 searches the basic program information 430 corresponding to the history information 710 from the program information table 400. Specifically, the basic program information 430 having the genre information 436 in the history information 710 and further having the keyword information 710 is searched. Then, the CPU 290 generates, the timer-recording information 520 based on the basic program information 430 searched by the program information managing unit 294B, and lists the generated timer-recording information 520 in the timer-recording list 500, and the process is terminated.

On the other hand, if the CPU 290 judges that the manual recording is judged to be requested in step S105, the step proceeds to the step S107 to generate the timer-recording information 720 (Translator's comment: correctly, timer-recording information 520). In other words, the CPU 290 generates, by the program information managing unit 294B, the timer-recording information 520 based on the read basic program information 430 that is recognized in the step S103 and corresponds to the TV program specified based on the specifying information, and lists the generated timer-recording information 520 in the timer-recording list 500, and the process is terminated.

As described above, by setting the timer-recording list 500, recording is performed by the recording controller 294C of the information retrieval controller 294. In other words, the contents data is appropriately received based on the timer-recording list 500 to be recorded in the HDD 270.

(Output Process)

The CPU 290 of the recording/reproducing device 200 judges, by the request information retriever 291, whether output request information as request information for outputting (viewing and reproducing) contents data of a predetermined TV program is input or not through an input operation of a user on the input unit 260 (step S201). In other words, the CPU 290 is in standby state for input of the output request information for requesting viewing or reproducing. Then, when the request information retriever 291 retrievers the output request information, the request information retriever 291 recognizes specifying information of the output request information (step S202).

After the step S202, the CPU 290 recognizes a detail of the contents data requested for viewing or reproducing, namely a genre or a keyword, based on the specifying information of the output request information recognized in the step S202. (step S203). Specifically, the detail recognizer 292 reads out the basic program information 430 corresponding to the TV program requested for viewing or corresponding to the contents data requested for reproducing that is recognized from the specifying information, based on the program information table 400 generated by the EPG data having been retrieved in advance. For the viewing request, the basic program information 430 is read out based on the program information table 400, while for the reproducing request, the targeted contents management information 610 is read out from the contents management information 610, so that the basic program information 430 associated with the contents management information 610 is read out, or the basic program information 430 is read out from the program information table 400 based on the associated program ID information 431. Then, the detail recognizer 292 retrieves the genre information 436 of the read basic program information 430 while extracting the keyword included in the basic program information 430 by the program information analyzer 292A to generate and retrieve the keyword information 712. The CPU 290 associates, based on the retrieved genre information 436 and keyword information 712, the genre information 436 and the keyword information 712, and if there are a plurality of the keyword information 712, each of them is associated with he program genre information 436 to generate the history information 710 by the history information generator 292B as an output history having a data structure.

Then, the CPU 290 computes detail frequency information 720 related to appearance frequency of the generated history information 710 by the detail frequency computer 293. That it so say, the CPU 290 judges whether the generated history information 710 exists in the history information 710 of the history frequency information 700, and if not exists, the CPU 290 lists the generated history information 710 in the history frequency information 700 and performs computation to set the detail frequency information to “1”. If exists, the CPU 290 performs computation to add “1” to the detail frequency information associated with the history information 710 (step S204).

After the step S204, the CPU 290 judges, by the reproduction controller 295, whether the viewing or the reproducing is requested based on the specifying information recognized in the step S202 (step S205). In the step S205, when the CPU 290 judges that the viewing is requested, the reproduction controller 295 receives the TV program currently being broadcasted based on the specifying information or the contents data based on the basic program information 430 read out corresponding to the TV program that is specified for scheduled viewing in the step S203 (step S206), which is appropriately processed to be output to the output device 300 (step S207), and the process is terminated.

On the other hand, in the step S205, when the CPU 290 judges that the reproducing is requested, the reproduction controller 295 controls the recording/reproducing processor 250 to read out the specified contents data from the HDD 270 based on the specifying information recognized in the step S202 (step S208), and the contents data is appropriately processed and the step proceeds to the step S 207, in other word, the contents data is output to the output device 300 and the process is terminated.

[Advantage of Contents Recording Reproducing System]

As described above, in the above embodiment, it is so controlled that, when the request information retriever 291 retrieves, through the communicator 210, the request information for receiving the contents data of the TV program related to a predetermined detail, e.g. the recording request information or the output request information for viewing, the user's preference is judged based on the detail frequency information 720 about the appearance frequency computed by the detail frequency computer 293 for the genre and the keyword as the detail of the requested contents data recognized by the detail recognizer 292, and the basic program information 430 is retrieved by the information retrieval controller 294 corresponding to the requested genre and keyword and depending on the appearance frequency as the user's preference, so that the contents data is received for recording or viewing. If, for instance, a receiving request such as recording or viewing based solely on the keyword and the genre, there might be a possibility to receive contents data that does not meet the user's preference. However, since the user's preference is set based on the receiving request, and the contents data to be received is set considering the user's preference, unnecessary contents data can be prevented from being retrieved. That is to say, inconvenience such as unnecessary consumption of the recording area of the HDD 270, a bothersome operation for selecting desired contents data from recorded contents data, and output of an unnecessary contents data can be prevented. Especially, the above embodiment is useful in retrieving the desired contents data based on the keyword or genre in the arrangement for retrieving the contents data of the TV program using the EPG data.

Further, for the judgment of the user's preference, the appearance frequency of the genre and the keyword as a detail related to the contents data is computed. Thus, the user's preference can be judged easily with a simple computing process for computing the appearance frequency based on a user's request history for recording, viewing or reproducing, etc. Therefore, the arrangement can be simplified and the process can be accelerated.

In computing the appearance frequency of a detail, a detail of reproduced contents data is also considered in addition to the receiving request such as request for recording or viewing. Thus, the user's preference can be judged more appropriately.

As the detail of the contents data, the keyword and the genre specifying the contents data are recognized, and the appearance frequencies of the genre and the keyword are computed. Thus, since the detail of the contents data can be easily recognized by the genre and the keyword based on the program information table 400 generated based on the EPG data related to the guide for TV programs, the detail can be easily recognized and the appearance frequency can be computed by a simple computing process using the genre information 436 and the keyword information 712 with small information amount, so that the user's frequency can be easily judged. Thus, the appropriate contents data can be received quickly with a simple arrangement.

Further, for computing the detail frequency using the genre and the keyword, a recording history, a viewing history and a reproducing history for the keyword and the genre are generated, so that the appearance frequency is computed based on the history information 710. Thus, a simple computing method in which the number of the history information 710 is counted can be used, which allows an easy computing of the detail frequency, so that the arrangement can be simplified and the process can be accelerated.

When the genre is set as the detail, the keyword included in the basic program information 430 of the genre is extracted, and the appearance frequency is computed using the history in which the genre and the keyword are associated. Thus, when the keyword is input, the user's preference can be recognized, and the contents data can be appropriately specified in accordance with the user's preference based both on the genre and the keyword, thereby enhancing the usability.

When the keyword is set as the detail, the basic program information 430 including the keyword is searched, and the appearance frequency is computed using the history in which the genre an the keyword are associated. Thus, even if words containing the same spelling such as “resutoran”, “osutoraria”, “hottorain” and “toraburu” are also searched for the keyword “tora”, since the appearance frequency is computed, the genre associated with the keyword and corresponding to the user's preference can be obtained, so that the appropriate contents data can be specified. Also, when the genre is input, the user's preference can be recognized, and the contents data can be appropriately specified in accordance with the user's preference based both on the genre and the keyword, thereby enhancing the usability.

In searching the basic program information 430 including the keyword, whether to include the keyword or not is judged by morphological analysis of the basic program information 430. Thus, the appearance frequency for searching words containing the same spelling such as “resutoran”, “osutoraria”, “hottorain”, and “toraburu” for the keyword of “tora” is lowered, and the basic program information 430 including the set keyword and corresponding to the user's preference can be searched, and thereby the contents data can be specified more appropriately.

In addition, the appearance frequencies of the genre and the keyword are computed from the basic program information 430 of the TV program specified in manual timer-recording where the user's preference is reflected. Thus, reliability of the computed appearance frequency can be easily enhanced, so that the contents data appropriately corresponding to the user's preference can be specified.

### Modification of Embodiment

The present invention is not limited to the above specific embodiment, but includes modifications as long as the objects of the present invention can be achieved.

As described above, although a system arrangement where the output device 300 for outputting the contents data is connected to the recording/reproducing device 200 having the information processor is exemplified, an arrangement having a recorder only for recording information or an arrangement having an independent information processor for recording information on a recorder or a recording/reproducing device may also be employed.

Information to be retrieved may include a radio program, a satellite broadcast program, distributed contents such as music and video, various programs such as game software and the like in addition to the TV program. It should be noted that, in retrieving other information, the information should be retrieved based on guide information about a guide for a detail of the information; for instance, in a case with application software, the software should be retrieved based on guide information disclosing the detail for downloading and recording the software.

Although the keyword and the genre are exemplified as the detail, as described above, any detail or a configuration related to the information to be retrieved such as title, channel, start time and information amount can be employed. Further, as for the computing process of the appearance frequency of the detail, any method such as the one based on the appearance frequency may be employed in addition to the above-described arrangement using the history.

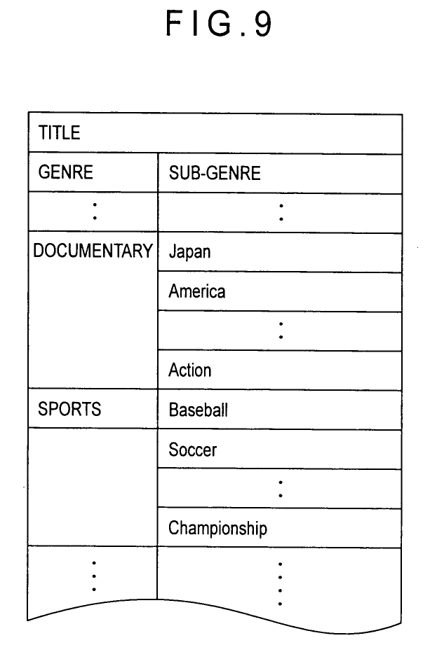

Although the appearance frequency is computed for the input keyword and genre based on the history in which the genre and the keyword are associated, but as an arrangement for considering the user's preference, the user may set the preference, for instance. For instance, as shown in FIG. 9, using a correlation table in which a plurality of sub-genres are associated with each genre, the set keyword is associated with the sub-genres, or a keyword included in the basic program information 430 including the set keyword is extracted, and when the keyword for the sub-genre is extracted, computing is performed to increase the appearance frequency of the genre. When the keyword is set, the automatic timer-recording may be performed by reading out the basic program information 430 including the set keyword and sub-genre.

The history information 710 generated by the history information generator 292B of the detail recognizer 292 is not limited to the arrangement including the genre information 436 and the keyword information 712. As a detail to be listed in the history, although an arrangement where the history of the detail of the contents data having been deleted is also stored is exemplified, a history having kept for a certain period of time (e.g. several years) may be automatically deleted. In such arrangement, information about date of the last recording or last reproducing of the data may be associated with the history information 710, which may be deleted based on current time detected by the timer. By eliminating the detail having been kept for a predetermined period of time from the history, the contents data can be retrieved based on the current preference even if the current preference of the user is different from the one in the past, and thereby the contents data desired by the user can be retrieved more appropriately.

For searching the basic program information 430 including the keyword, any method can be applied such as a searching method, for instance, based on identity of strings, without limiting to the searching method using morphological analysis.

In the above description, although the appearance frequency in the history information 710 is computed for each of the recording request, viewing request and reproducing request, the appearance frequency may be computed for one of them or for any combination of them. Especially, as described above, by computing the appearance frequency based on the viewing request and the reproducing request directly related to the user's preference, the information meeting the user's preference more appropriately can be retrieved.

Although various functions described above are arranged as programs, any arrangement may be employed including, for instance, hardware such as circuit board or an element such as IC In view of easy handling and promotion of the use, the functions are preferably stored and read from programs or recording media, and further, an arrangement where a computing unit such as computer serves as an information processor (CPU) and the recording/reproducing device 200 can be realized with ease.

The arrangements and the operating procedures for the present invention may be appropriately modified as long as the scope of the present invention can be attained.

### Advantage of Embodiment

As described above, in the above embodiment, it is so controlled that, when the request information retriever 291 retrieves, through the communicator 210, the request information for receiving the contents data of the TV program related to a predetermined detail, e.g. the recording request information or the output request information for viewing, and based on the detail frequency information 720 about the appearance frequency computed by the detail frequency computer 293 for the genre and the keyword as the detail of the requested contents data recognized by the detail recognizer 292, the basic program information 430 is retrieved by the information retrieval controller 294 in accordance with the requested genre and keyword and depending on the appearance frequency for receiving the contents data. If, for instance, the receiving request is based solely on the keyword and the genre, there might be a possibility to receive contents data that does not meet the user's preference. However, since the user's preference is specified by the appearance frequency based on the receiving request, and the contents data to be received is specified considering the user's preference, unnecessary contents data can be prevented from being retrieved, so that the desired contents data can be appropriately retrieved.

The priority application Number JP2004-164935 upon which this patent application is based is hereby incorporated by reference.

1. An information processor for retrieving information of a predetermined detail based on guide information about a guide of the information by an information retriever, the information processor comprising:
a request information retriever for retrieving request information for retrieving the information having the predetermined detail by the information retriever;
a detail recognizer for recognizing a detail of the information retrieved by the information retriever based on the guide information;
a detail frequency computer for generating detail frequency information obtained by computing an appearance frequency of the recognized content; and
an information retrieval controller for controlling the information retriever, when retrieval of the request information is recognized, to retrieve the information based on the guide information of the guide corresponding to the predetermined detail and corresponding to the detail according to the appearance frequency in the detail frequency information.

2. The information processor according to claim 1, wherein
the detail recognizer recognizes the detail of the information processed by an information processing unit for processing the information, and
the detail frequency computer computes the appearance frequency of the detail to generate detail frequency information based on the detail of the retrieved information recognized by the detail recognizer and the detail of the processed information.

3. An information processor for retrieving information of a predetermined detail based on guide information about a guide of the information by an information retriever, the information processor comprising:
a request information retriever for retrieving request information for retrieving the information having the predetermined detail by the information retriever;
a detail recognizer for recognizing a detail of the information processed by an information processing unit for processing the information,
a detail frequency computer for generating detail frequency information obtained by computing an appearance frequency of the recognized content; and
an information retrieval controller for controlling the information retriever, when retrieval of the request information is recognized, to retrieve the information based on the guide information of the guide corresponding to the predetermined detail and corresponding to the detail according to the appearance frequency in the detail frequency information.

4. The information processor according to claim 3, wherein
the detail recognizer recognizes the detail of the information retrieved by the information retriever, and
the detail frequency computer computes the appearance frequency of the detail to generate detail frequency information based on the detail of the retrieved information recognized by the detail recognizer and the detail of the processed information.

5. The information processor according to claim 1, wherein
the request information retriever retrieves request information including keyword-related information related to at least one of a keyword for specifying a detail of the information, a related keyword related to the keyword, and a related detail of the keyword, and
the information retrieval controller controls to retrieve the information based on the guide information of the guide including at least one of the keyword, the related keyword and the related detail, the guide corresponding to the detail depending on the appearance frequency of the detail frequency information.

6. The information processor according to claim 3, wherein
the request information retriever retrieves request information including keyword-related information related to at least one of a keyword for specifying a detail of the information, a related keyword related to the keyword, and a related contents of the keyword, and
the information retrieval controller controls to retrieve the information based on the guide information of the guide including at least one of the keyword, the related keyword and the related detail, the guide corresponding to the detail depending on the appearance frequency of the detail frequency information.

7. The information processor according to claim 1, further comprising:
a history information generator for generating history information about history of the detail of the information recognized by the detail recognizer, wherein
the detail frequency computer computes the appearance frequency of the detail based on the history information to generate detail frequency information.

8. The information processor according to claim 3, further comprising:
a history information generator for generating history information about history of the detail of the information recognized by the detail recognizer, wherein
the detail frequency computer computes the appearance frequency of the detail based on the history information to generate detail frequency information.

9. The information processor according to claim 7, wherein
the history information generator generates the history information based on type information about a type included in the guide information of the guide corresponding to the detail of the information,
the detail frequency computer computes the appearance frequency for each type of the detail of the history information to generate the detail frequency information, and
the information retrieval controller retrieves the information based on the guide information of the guide corresponding to the predetermined detail and having the type depending on the appearance frequency of the each type in the detail frequency information.

10. The information processor according to claim 8, wherein
the history information generator generates the history information based on type information about a type included in the guide information of the guide corresponding to the detail of the information,
the detail frequency computer computes the appearance frequency for each type of the detail of the history information to generate the detail frequency information, and
the information retrieval controller retrieves the information based on the guide information of the guide corresponding to the predetermined detail and having the type depending on the appearance frequency of the each type in the detail frequency information.

11. The information processor according to claim 7, wherein
the history information generator generates history information about a history of keyword-related information related to at least one of a keyword included in a guide corresponding to the detail of the information in guide information, a related keyword related to the keyword, and a related contents of the keyword,
the detail frequency computer computes the appearance frequency of the keyword-related information related to at least one of the keyword in the history information, the related keyword related to the keyword, and the related contents of the keyword to generate detail frequency information, and
the information retrieval controller controls to retrieve the information corresponding to the predetermined detail and based on guide information of a guide including a word with high appearance frequency in the detail frequency information.

12. The information processor according to claim 8, wherein
the history information generator generates history information about history of keyword-related information related to at least one of a keyword included in a guide corresponding to the detail of the information in guide information, a related keyword related to the keyword, and a related contents of the keyword,
the detail frequency computer computes the appearance frequency of the keyword-related information regarding at least one of the keyword in the history information, the related keyword related to the keyword, and the related contents of the keyword to generate detail frequency information, and
the information retrieval controller controls to retrieve the information corresponding to the predetermined detail and based on guide information of a guide including a word with high appearance frequency in the detail frequency information.

13. The information processor according to claim 1, wherein
the detail frequency computer computes the appearance frequency of keyword-related information related to at least one of a keyword in a guide of guide information corresponding to the recognized detail, a related keyword related to the keyword, and a related detail of the keyword to generate detail frequency information, and
the information retrieval controller retrieves the information based on the guide information of a guide corresponding to the predetermined detail based on the detail frequency information, the guide including the keyword-related information related to at least one of a keyword with high frequency, a related keyword related to the keyword, and a related detail related to the keyword.

14. The information processor according to claim 3, wherein
the detail frequency computer computes the appearance frequency of keyword-related information related to at least one of a keyword in a guide of guide information corresponding to the recognized detail, a related keyword related to the keyword, and a related detail of the keyword to generate detail frequency information, and
the information retrieval controller retrieves the information based on the guide information of a guide corresponding to the predetermined detail based on the detail frequency information, the guide including the keyword-related information related to at least one of a keyword with high frequency, a related keyword related to the keyword, and a related detail related to the keyword.

15. The information processor according to claim 11, wherein
the detail frequency information is generated by computing the appearance frequency of keyword-related information related to at least one of a keyword extracted by morphological analysis from a guide of guide information corresponding to the recognized detail, a related keyword related to the keyword, and a related detail of the keyword.

16. The information processor according to claim 12, wherein
the detail frequency information is generated by computing the appearance frequency of keyword-related information related to at least one of a keyword extracted by morphological analysis from a guide of guide information corresponding to the recognized detail, a related keyword related to the keyword, and a related detail of the keyword.

17. The information processor according to claim 1, wherein
the information is one of a contents that is broadcasted or distributed and a sharable contents that is created by an individual, and
the guide information is information about at least one of a name and a detail of the contents.

18. The information processor according to claim 3, wherein
the information is one of a contents that is broadcasted or distributed and a sharable contents that is created by an individual, and
the guide information is information about at least one of a name and a detail of the contents.

19. An information recorder, comprising:
an information retrieval controller for retrieving information;
a storage for storing the retrieved information;
a guide information retriever for retrieving guide information about a guide of the information; and
an information processor for controlling the information retriever based on the guide information to retrieve the information of a predetermined detail, the information processor including:
a request information retriever for retrieving request information for retrieving the information having the predetermined detail by the information retriever;
a detail recognizer for recognizing a detail of the information retrieved by the information retriever based on the guide information;
a detail frequency computer for generating detail frequency information obtained by computing an appearance frequency of the recognized content; and
an information retrieval controller for controlling the information retriever, when retrieval of the request information is recognized, to retrieve the information based on the guide information of the guide corresponding to the predetermined detail and corresponding to the detail according to the appearance frequency in the detail frequency information.

20. An information recorder, comprising:
an information retriever for retrieving information;
a storage for storing the retrieved information;
a guide information retriever for retrieving guide information about a guide of the information; and
an information processor for controlling the information retriever based on the guide information to retrieve the information of a predetermined detail, the information processor including:
a request information retriever for retrieving request information for retrieving the information having the predetermined detail by the information retriever;
a detail recognizer for recognizing a detail of the information processed by an information processing unit for processing the information,
a detail frequency computer for generating detail frequency information obtained by computing an appearance frequency of the recognized content; and
an information retrieval controller for controlling the information retriever, when retrieval of the request information is recognized, to retrieve the information based on the guide information of the guide corresponding to the predetermined detail and corresponding to the detail according to the appearance frequency in the detail frequency information.

21. An information processing method in which a computing unit retrieves information of a predetermined detail based on guide information about a guide of the information by an information retriever, the information processing method comprising the steps of:
recognizing a detail of the information retrieved by the information retriever based on the guide information;
generating detail frequency information by computing an appearance frequency of the recognized content; and
retrieving by the information retriever, when recognizing request information for retrieving the information of the predetermined detail, the information based on the guide information of the guide corresponding to the predetermined detail and corresponding to the detail according to the appearance frequency in the detail frequency information.

22. An information processing method in which a computing unit retrieves information of a predetermined detail based on guide information about a guide of the information by an information retriever, the information processing method comprising the steps of:
recognizing a detail of the information processed by an information processor for processing the information, and
generating detail frequency information by computing an appearance frequency of the recognized content; and
retrieving by the information retriever, when recognizing request information for retrieving the information of the predetermined detail, the information based on the guide information of the guide corresponding to the predetermined detail and corresponding to the detail according to the appearance frequency in the detail frequency information.

23. An information processing program that operates a computing unit to function as an information processor for retrieving information of a predetermined detail based on guide information about a guide of the information by an information retriever, the information processor including:
a request information retriever for retrieving request information for retrieving the information having the predetermined detail by the information retriever;
a detail recognizer for recognizing a detail of the information retrieved by the information retriever based on the guide information;
a detail frequency computer for generating detail frequency information obtained by computing an appearance frequency of the recognized content; and
an information retrieval controller for controlling the information retriever, when retrieval of the request information is recognized, to retrieve the information based on the guide information of the guide corresponding to the predetermined detail and corresponding to the detail according to the appearance frequency in the detail frequency information.

24. An information processing program that operates a computing unit to function as an information processor for retrieving information of a predetermined detail based on guide information about a guide of the information by an information retriever, the information processor including:
a request information retriever for retrieving request information for retrieving the information having the predetermined detail by the information retriever;
a detail recognizer for recognizing a detail of the information processed by an information processing unit for processing the information,
a detail frequency computer for generating detail frequency information obtained by computing an appearance frequency of the recognized content; and
an information retrieval controller for controlling the information retriever, when retrieval of the request information is recognized, to retrieve the information based on the guide information of the guide corresponding to the predetermined detail and corresponding to the detail according to the appearance frequency in the detail frequency information.

25. An information processing program that operates a computing unit to execute an information processing method for retrieving information of a predetermined detail based on guide information about a guide of the information by an information retriever, the method including the steps of:
recognizing a detail of the information retrieved by the information retriever based on the guide information;
generating detail frequency information by computing an appearance frequency of the recognized content; and
retrieving by the information retriever, when recognizing request information for retrieving the information of the predetermined detail, the information based on the guide information of the guide corresponding to the predetermined detail and corresponding to the detail according to the appearance frequency in the detail frequency information.

26. An information processing program that operates a computing unit to execute an information processing method for retrieving information of a predetermined detail based on guide information about a guide of the information by an information retriever, the method including the steps of:
recognizing a detail of the information processed by an information processor for processing the information, and
generating detail frequency information by computing an appearance frequency of the recognized content; and
retrieving by the information retriever, when recognizing request information for retrieving the information of the predetermined detail, the information based on the guide information of the guide corresponding to the predetermined detail and corresponding to the detail according to the appearance frequency in the detail frequency information.

27. A recording medium storing an information processing program in a manner readable by a computing unit, the information processing program operating the computing unit to function as an information processor for retrieving information of a predetermined detail based on guide information about a guide of the information by an information retriever, the information processor including:
a request information retriever for retrieving request information for retrieving the information having the predetermined detail by the information retriever;
a detail recognizer for recognizing a detail of the information retrieved by the information retriever based on the guide information;
a detail frequency computer for generating detail frequency information obtained by computing an appearance frequency of the recognized content; and
an information retrieval controller for controlling the information retriever, when retrieval of the request information is recognized, to retrieve the information based on the guide information of the guide corresponding to the predetermined detail and corresponding to the detail according to the appearance frequency in the detail frequency information.

28. A recording medium storing an information processing program in a manner readable by a computing unit, the information processing program operating the computing unit to function as an information processor for retrieving information of a predetermined detail based on guide information about a guide of the information by an information retriever, the information processor including:
a request information retriever for retrieving request information for retrieving the information having the predetermined detail by the information retriever;
a detail recognizer for recognizing a detail of the information processed by an information processing unit for processing the information,
a detail frequency computer for generating detail frequency information obtained by computing an appearance frequency of the recognized content; and
an information retrieval controller for controlling the information retriever, when retrieval of the request information is recognized, to retrieve the information based on the guide information of the guide corresponding to the predetermined detail and corresponding to the detail according to the appearance frequency in the detail frequency information.

29. A recording medium storing an information processing program in a manner readable by a computing unit, the information processing program operating the computing unit to execute an information processing method for retrieving information of a predetermined detail based on guide information about a guide of the information by an information retriever, the method including the steps of:
recognizing a detail of the information retrieved by the information retriever based on the guide information;
generating detail frequency information by computing an appearance frequency of the recognized content; and
retrieving by the information retriever, when the information retriever recognizes request information for retrieving the information of the predetermined detail, the information based on the guide information of the guide corresponding to the predetermined detail and corresponding to the detail according to the appearance frequency in the detail frequency information.

30. A recording medium storing an information processing program in a manner readable by a computing unit, the information processing program operating the computing unit to execute an information processing method for retrieving information of a predetermined detail based on guide information about a guide of the information by an information retriever, the method including the steps of:
recognizing a detail of the information processed by an information processor for processing the information, and
generating detail frequency information by computing an appearance frequency of the recognized content; and
retrieving by the information retriever, when the information retriever recognizes request information for retrieving the information of the predetermined detail, the information based on the guide information of the guide corresponding to the predetermined detail and corresponding to the detail according to the appearance frequency in the detail frequency information.
